(19) United States
(12) Patent Application Publication
(10) Pub. No.: US 2006/0050522 A1
(43) Pub. Date: Mar. 9, 2006

(54) Vehicle interior lighting assembly

(76) Inventor: Tony Chen, Jung-He City (TW)

Correspondence Address: Yi-Wen Tseng, 4331 Stevens Battle Lane, Fairfax, VA, 22033, US

(21) Appl. No.: 10/934,587

(22) Filed: Sep. 3, 2004

(51) Int. Cl. B60Q 1/26

(52) U.S. Cl. 362/488; 362/487; 362/510

(57) ABSTRACT

A vehicle interior lighting assembly is disclosed. The vehicle interior lighting assembly includes a casing disposed in the interior space of a vehicle, a lighting means disposed in the casing, a control means for controlling and switching the lighting means, a finetuner means coupled to the lighting means for adjusting the illumination of the lighting means. The light means of the present assembly comprise a plurality of the lighting elements. The plurality of the lighting elements can be controlled and adjusted by the finetuner means and thus, provide various illumination of the present lighting assembly to fulfill the users' requirements.

### BACKGROUND OF THE INVENTION

The present invention is related to a vehicle interior lighting assembly, and particularly, to a vehicle interior lighting assembly with adjustable illumination which can be adjusted by a fine tuner according to the user's request.

Current internal lights of a vehicle include a reading light disposed on the ceiling of the front seats or C-frame of a vehicle and a headlight on the central of the ceiling of a vehicle. The lights of a vehicle, such as reading light and headlight, are fixedly disposed on the ceiling thereof. The operations of these interior lights are controlled by electronic switches via on/off mechanism. In other words, the lights are controlled in only two modes, on and off. However, for fulfilling the illumination requirement of the interior of a vehicle, the light assembly should reach a certain illumination. When a vehicle is running in the night time and to switch on a reading light or headlight is requested, the interior light can be switch on only to a full illumination, such an illumination is too bright to affect the driver's vision. Especially, when the interior light is last for a while, the driver's vision to the outside environment is affected.

Thus, a vehicle interior light with adjustable illumination is demanded.

### BRIEF SUMMARY OF THE INVENTION

The present invention is to provide a vehicle interior lighting assembly with an adjustable illumination. The illumination of lighting assembly can be adjustable to fulfill the user's requirement and practical using conditions and to avoid affecting the driver's vision.

The present invention is to provide a vehicle interior lighting assembly with an adjustable illumination, wherein a finetuner means is provided to couple to the control means of a plurality of lighting elements of the assembly for executing the selection and/or on-off of light means.

Accordingly, the vehicle interior lighting assembly includes a casing disposed in the interior space of a vehicle, a lighting means disposed in the casing, a control means for controlling and switching the lighting means, a finetuner means coupled to the lighting means for adjusting the illumination of the lighting means.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is a block diagram of a preferred embodiment of the present invention;

FIG. 2 is a circuit diagram of a preferred embodiment of the present invention;

FIG. 3 is a perspective view of a preferred embodiment of the lighting assembly of the present invention;

FIG. 4 is a perspective view of another preferred embodiment of the lighting assembly of the present invention; and

FIG. 5 is a perspective view of another preferred embodiment of the lighting assembly of the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

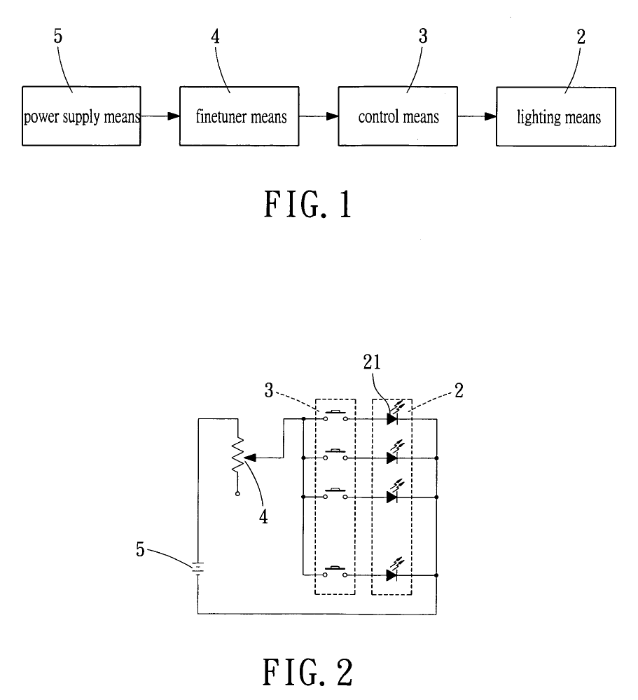

FIGS. 1 and 2 are diagrams of a preferred embodiment of the present invention. The vehicle interior lighting assembly of the present invention comprises a casing 1, a lighting means 2 received in the casing 1, a control means 3 electronically coupled to a power supply means 5, a finetuner means 4 coupled to the lighting means 2. The illumination of the light assembly of the present invention is accordingly able to be manual controlled.

The lighting means 2 is fixed disposed in the casing 1. The light illuminated by lighting means 2 is trough the casing to light up the vehicle interior space. The lighting means 2 of a preferred embodiment of the present invention comprises a plurality of lighting elements 21, as illustrated in FIG. 2. In the preferred embodiment of the FIG. 2, the lighting elements 21 can be LEDs (Light Emitting Diode), commercial light bulbs, commercial fluorescent pipes or the combination thereof in accordance with the different requirement of vehicle interior illumination requirement. In a preferred embodiment, the lighting elements 21 can be LED with different color illumination.

The lighting elements 21 disposed in lighting means 2 are controlled by control means 3 coupled to a power supply means 5 for controlling the power on/off function thereof. Thus, the lighting elements 21 can be selectively powered on for creating different illumination effect. Moreover, a different color illumination can be achieved when the lighting elements 21 is able to emit different color light.

In a preferred embodiment, a finetuner means 4 is electronically coupled between the lighting elements 21 and power supply means 5. A user can adjust the illumination of the lighting means easily by manual operation. In FIGS. 1 and 2, the finetuner means 4 is an adjustable resistance element. Preferably, the finetuner means 4 is able to be a combination of an adjustable resistance element and a on/off switch element for controlling both of the illumination of the lighting means and the power on/off thereof.

The finetuner element 4, in a preferred embodiment, is disposed on the casing 1 for the driver to easily use and control the lighting assembly.

The vehicle interior lighting assembly of the present invention further comprises a casing 1 as a receptacle for the lighting means 2, the control means 3 and the finetuner means 4. The casing 1 is able to be fixed to the interior construction of a vehicle. The casing is acted as a receptacle for lighting means 2, control means 3 and finetuner means 4. The casing is transparent for the bright emitted from light means 2 getting through to the interior space of the vehicle.

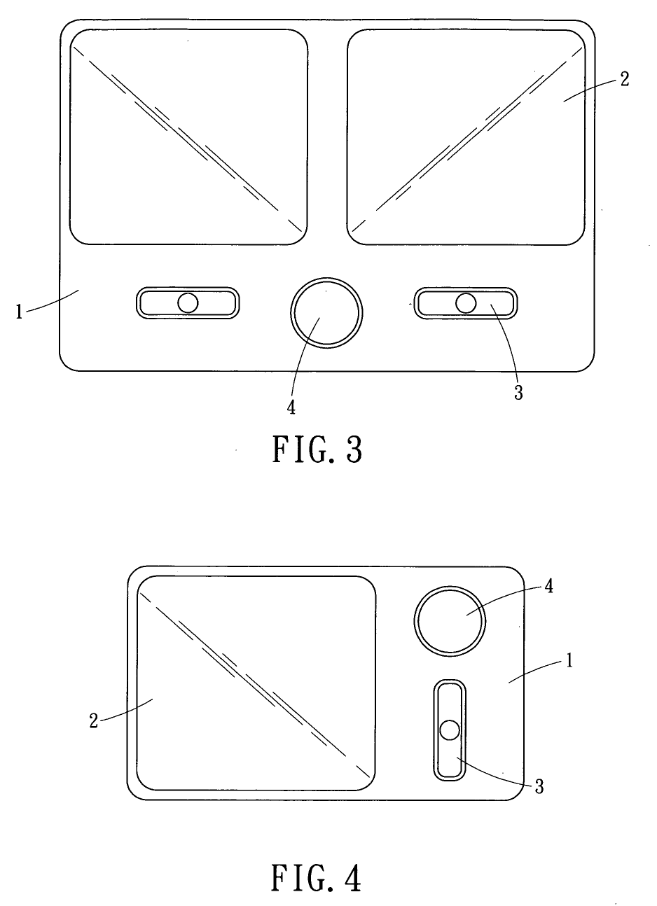

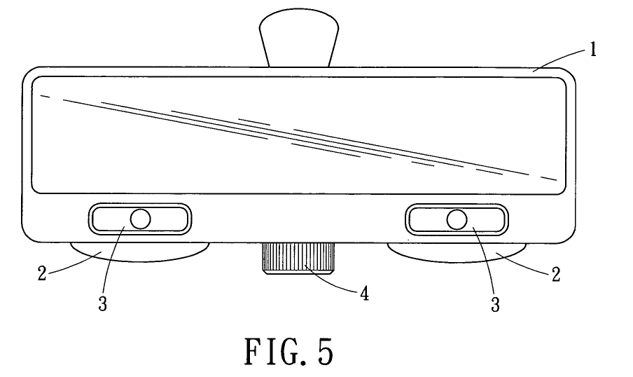

In a preferred embodiment of the present invention, the casing of the vehicle interior lighting assembly is able to fix on the ceiling or the C-frame of a vehicle, as shown in FIG. 3. One embodiment of the present invention shown in FIG. 4, the interior lighting assembly is used as headlight assembly fixed on the center or the aside of ceiling of a vehicle. Another one embodiment of the present invention shown in FIG. 5, the interior lighting assembly is fixed with the rear mirror assembly.

According to the assembly of the present invention, as shown in FIGS. 3 to 5, the vehicle interior lighting assembly is fixed to the vehicle interior construction via the casing 1. Thus, the casing 1 is able to be constructed for the different purposes, such as constructed as a reading lamp, as a headlamp and sidelamp and accordingly, fixed at different positions in the vehicle interior. The illumination and the switch of the lighting elements 21 is easily to be controlled by the drivers via the control circuit as shown in FIGS. 1 to 2. The drivers can operate the finetuner means 4 to control the lighting means 2 for powering on the lighting elements 21 and the emitting level thereof. In other words, the vehicle interior lighting assembly of the present invention is superior to the conventional lighting assembly on the control operation of the power on/off of the assembly due to the finetuner means of the present assembly. Furthermore, the drivers can easily control the illumination of the interior lighting assembly. The drivers or users can easily operate the control means 3 to control the illumination of the lighting means 2, further to control the illumination of the lighting elements 21 of the lighting means 2. Therefore, the lighting means 2 can be a combination of different color lighting elements 21, of a combination of different types of lighting elements, such as the LEDs, lamp bulbs, fluorescent pipes or a combination thereof. Accordingly, the vehicle interior lighting assembly of the present invention provides a variety of illumination and is able to fulfill the users' requirements.

The advantages and purposes of the present invention are accordingly as follows,

1. The light means comprise a plurality of the lighting elements. The plurality of the lighting elements can be controlled and adjusted by the finetuner means and thus, provide various illumination of the present lighting assembly to fulfill the users' requirements.

2. The lighting means includes a plurality of light elements. The illumination of the lighting means can be directly controlled by the switch means to operate the on/off function of the lighting elements. The lighting elements can also be controlled by the switch means to be controlled and/or adjusted the color of the illumination of the present lighting assembly. Comparing to the conventional vehicle interior lighting means, the present vehicle interior lighting assembly can provide various illumination and fulfill the users' requirements.

3. The vehicle interior lighting assembly of the present invention can used as a reading lam, headlight, or a sidelamp in accordance with the construction of the casing and the fixed position of the vehicle interior space.

4. The finetuner means of the vehicle interior lighting assembly for adjusting the illumination thererof can be fixed on the casing for users' easy control.

5. The power supply can be supplied by the vehicle or supplied by batteries disposed in the casing.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A vehicle interior lighting assembly, comprising:
a casing disposed in the interior space of a vehicle;
a lighting means disposed in the casing;
a control means for controlling and switching the lighting means; and
a finetuner means coupled to the lighting means for adjusting the illumination of the lighting means.

2. The assembly as claimed in claim 1, wherein the lighting means comprises a plurality of lighting elements.

3. The assembly as claimed in claim 1, wherein lighting means comprises a plurality of lighting elements illuminating different color.

4. The assembly as claimed in claim 2, the lighting elements can be one of LEDs, lamp bulbs, fluorescent pipes and combination thereof.

5. The assembly as claimed in claim 1, wherein the casing is for a reading lamp.

6. The assembly as claimed in claim 1, wherein the casing is for a headlight.

7. The assembly as claimed in claim 1, wherein the casing is together used with rear mirror assembly.

8. The assembly as claimed in claim 1, wherein the control means is an adjustable resistance.

9. The assembly as claimed in claim 1, wherein the control means is an adjustable resistance together with a switch means.

10. The assembly as claimed in claim 1, wherein the control means is disposed on the casing.

11. The assembly as claimed in claim 1, wherein the power of lighting means is supplied by power supply means.

12. The assembly as claimed in claim 1, wherein the power of lighting means is supplied by vehicle batteries.
